(19) United States
(12) Patent Application Publication
(10) Pub. No.: US 2014/0331629 A1
(43) Pub. Date: Nov. 13, 2014

(54) Fruit Harvesting Machine and Method

(71) Applicant: Automated AG Systems, LLC, Tampa, FL (US)

(72) Inventor: John J. Dagorret, Moses Lake, WA (US)

(73) Assignee: AUTOMATED AG SYSTEMS, LLC, Tampa, FL (US)

(21) Appl. No.: 14/270,387

(22) Filed: May 6, 2014

Related U.S. Application Data
(60) Provisional application No. 61/822,068, filed on May 10, 2013.

(51) Int. Cl. A01D 46/20

(52) U.S. Cl. CPC A01D 46/20
USPC 56/10.1; 56/328.1

(57) ABSTRACT

A fruit harvesting machine that includes a bin storage compartment into which multiple produce bins can be received and collected for transport out of an orchard or field. Bins may be moved about the storage compartment via rollers and lifted via a bin lift system. Filled bins may be replaced by new bins with minimal interruption to the harvesting operation. The machine may also include drive components, hydraulics, an operating console, and other systems.

### CROSS-REFERENCE TO RELATED APPLICATIONS

This application is a nonprovisional application of and claims priority from U.S. provisional patent application Ser. No. 61/822,068 filed on May 10, 2013. The foregoing applications are incorporated in their entirety herein by reference.

### FIELD OF THE INVENTION

The invention relates to a system and method for harvesting items. More particularly, the invention relates to a system and method for collecting and transporting fruits and vegetables in bins.

### BACKGROUND

Conventional produce-collecting machines are standard-sized tractors and trailers drawn behind those tractors. Standard-sized tractors and trailers can navigate standard-sized field cultivation and orchard rows; however, they are typically unable to navigate narrow rows used for dwarf varieties of fruit trees or for high-density row planting. Many crop plants may be planted in rows with less space between each row to increase the density of plants, thereby yielding a larger amount of produce from each crop. The same holds true for dwarf variety apples and other dwarf fruit trees, which may be planted in closely spaced rows to maximize the size of the harvest. Conventional tractors and trailers are too wide to navigate these closely spaced plant rows. The widely spaced rows required to accommodate conventional farming equipment results in a loss of efficiency from the perspective of space usage and plant density as well as reduced harvest size.

Additionally, harvesting fruit and vegetable crops manually may be a tedious and laborious task. As an example, harvesting of apples may require climbing a tree or using a ladder. In addition, the apples may need to be collected in a bin that may be inconveniently located a distance away from the person harvesting the apples. Furthermore, bins may be heavy, which may increase the difficulty of locating the bin near a person harvesting the fruit or other crops.

A need exists for a fruit harvesting machine to improve harvesting efficiency so that crops picked in fields and orchards having closely spaced rows may be mechanically transported quickly and efficiently out of the field or orchard. A need also exists for a fruit harvesting machine that facilitates the harvesting of fruit or crops while positioning and/or maintaining a bin in close proximity to the harvesting individual. Additionally, a need exists for a fruit harvesting machine that facilitates exchanging filled bins with new bins to continuously collect fruit or crops.

### SUMMARY

The present invention provides a fruit harvesting machine for harvesting crops in fields and orchards having closely spaced rows that may mechanically transport the crops out of the field or orchard quickly and efficiently. The present invention also provides a fruit harvesting machine that facilitates the harvesting of fruit while positioning and/or maintaining the bin in close proximity to the harvester. Additionally, the present invention provides a fruit harvesting machine that facilitates exchanging filled bins with new bins to continually collect fruit or crops.

The fruit harvesting machine may include a frame, on which other components may be attached and/or located. The frame may include an upper portion and a lower portion. Adjacent to the upper portion of the frame may be one or more standing platforms on which harvesting individuals may stand, an operating console, arms, railings, and other components. Adjacent to the lower portion of the frame may be one or more drive components, parts, wheels, a bin storage compartment with one or more rollers, prongs, a bin lift system, and other components. The bin lift system may be included to elevate the bin between vertical positions of a lowered position approximately level with the bin storage compartment, a raised portion approximately level with the platforms, or an intermediary position.

The machine and methods described herein may have a frame of maximum widths narrower than those of standard-sized tractors. The machine may also feature an operating console containing steering, drive, hydraulic, and other controls. The operating console may be elevated by the upper portion of the frame, which may be above the bin storage compartment. The bin storage compartment may be located and supported by the lower portion of the frame and may include a front portion and a rear portion. The front portion and/or rear portion of the bin storage compartment can include one or more prongs that can be lowered and raised to lift bins into the storage compartment and remove bins from the storage compartment. The prongs and other portions of the storage compartment can include rollers, such as chain rollers, that may be mechanically controlled and operated. The chain rollers may be connected to a motor or other drive mechanism that is reversible so that the direction and/or rate of movement of the chain rollers can be controlled by a user. The chain rollers may circulate in a direction toward the rear portion of the storage compartment when bins are being loaded into the storage compartment. When bins are being unloaded from the storage compartment, the direction of movement of the chain rollers can be reversed to circulate toward the front portion of the storage compartment.

The fruit harvesting machine can be manufactured with a maximum width that enables the tractor to navigate narrow rows or fruit trees, e.g., dwarf apple or dwarf citrus trees, or other narrowly spaced rows of produce such as vegetables between which conventional tractors are unable to move.

According to an embodiment of the present invention, a fruit harvesting machine is provided with a frame, platform, bin storage compartment, bin lift system, operating console, and drive components. The frame may include an upper portion and a lower portion. The platform may be located at the upper portion. The bin storage compartment may be located at the lower portion. The bin lift system may move a bin between the lower portion and the upper portion. The operating console may be accessible from the platform. The drive components may be attached to the frame to move the machine. One or more wheels may be operatively attached to the frame. The drive components may be at least partially controllable via the operating console. The bin is movable about the bin storage compartment when located in the lower portion. Additionally, the bin is storable in the lower portion.

In another aspect, the drive components further include an engine, and a transmission.

In another aspect, further including a suspension located between the frame and the wheel.

In another aspect, the suspension is an air ride suspension.

In another aspect, the machine includes rollers located in the lower portion to move the bin.

In another aspect, the maximum width of the frame is sufficiently narrow to navigate between closely spaced rows of plants.

In another aspect, the machine includes prongs located in the lower portion to receive the bin into the bin storage compartment.

In another aspect, the prongs additionally guide the bin out of the bin storage compartment.

In another aspect, the machine includes hydraulics.

In another aspect, the bin lift system is manipulated between a lowered position and a raised position via the hydraulics.

In another aspect, the machine includes an arm, wherein a light is installable on the arm.

In another aspect, the bin lift system includes a scissor lift mechanism.

In another aspect, the machine includes a camera and a monitor to facilitate loading and unloading of the bin.

In another aspect, the drive components include an auto-steering mechanism to manipulate the wheel.

In another aspect, the auto-steering mechanism navigates the machine along an anticipated path.

In another aspect, the machine includes a bloom thinner removably connectable to the machine.

In another aspect, further including attachable components that are temporarily attachable to the machine, the attachable components including at least one component selected from, a lopper, a pruner, and/or a bloom thinner.

According to an embodiment of the present invention, a method is provided for operating a harvesting machine. The machine may include a frame including an upper portion and a lower portion, a bin lift system, drive components, and an operating console. The method includes navigating the machine to a location with items to harvest via the drive components. The method also includes receiving a bin into a bin storage compartment located in the lower portion. The method includes moving the bin within the bin storage compartment via rollers. Additionally, the method includes locating the bin approximately above the bin lift system that is oriented in a lowered position. The method includes operating the bin lift system to transition from the lowered position to a raised position to lift the bin approximately to the upper portion, the bin lift system in the raised position being approximately level with a platform located in the upper portion. The method also includes harvesting the items. Furthermore, the method includes depositing the items that are harvested in the bin. The drive components are controllable via the operating console.

In another aspect, the method includes exchanging the bin that is substantially full with the bin that is substantially empty, which is repeatable.

In another aspect, the step of exchanging the bin further includes operating the bin lift system to transition from the raised position to the lowered position to lower the bin that is substantially full; locating the bin that is substantially full away from the bin lift system; locating the bin that is substantially empty above the bin lift system; and operating the bin lift system to transition from the lowered position to the raised position to lift the bin that is substantially empty approximately to the upper portion, the bin lift system in the raised position being approximately level with the platform.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a side elevation view of a fruit harvesting machine, according to an embodiment of the present invention.

FIG. 2 is a side of the fruit harvesting machine of FIG. 1 with the bin lift system extended in the raised position.

FIG. 3 is a top plan view of the bottom portion of the fruit harvesting machine of FIG. 1.

FIG. 4 is a partial side elevation view of the fruit harvesting machine of FIG. 1 with the bin lift system extended in the raised position.

FIG. 5 is a partial side elevation view of the fruit harvesting machine of FIG. 1 with the bin lift system retracted in the lowered position.

FIG. 6 is a partial side elevation view of the fruit harvesting machine of FIG. 1 with the prongs lowered.

FIG. 7 is a rear perspective view of the fruit harvesting machine storing a bin, according to an embodiment of the present invention.

FIG. 8 is a perspective view of the fruit harvesting machine, according to an embodiment of the present invention.

FIG. 9 is a block diagram illustrating the drive components, according to an embodiment of the present invention.

FIG. 10 is a side elevation view of a bloom thinning attachment, according to an embodiment of the present invention.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The present invention will now be described in detail with reference to embodiments thereof as illustrated in the accompanying drawings. In the following description, a fruit harvesting machine will be discussed. Those of skill in the art will appreciate alternative labeling of the fruit harvesting machine as a crop harvesting machine, crop harvester, fruit harvester, harvester, machine, device, system, the invention, or other similar names. Skilled readers should not view the inclusion of any alternative labels as limiting in any way.

The invention provides systems and methods for collecting and transporting harvested produce from fields and orchards, which may have standard- or substandard-sized row widths. Specifically, the invention relates to a fruit harvesting machine capable of carrying and positioning one or more bins near a user to facilitate the collection and/or storage of items such as fruit or other crops from a field, orchard, or other location from which the fruit or crops may be grown. In an embodiment of the present invention, the fruit harvesting machine may have a width that is less wide than a standard harvesting machine to permit navigating between rows of plants less wide than standard-sized rows. For example, the fruit harvesting machine may be particularly designed to navigate rows of dwarf variety fruit trees such as, for example, dwarf variety apple trees, in orchards.

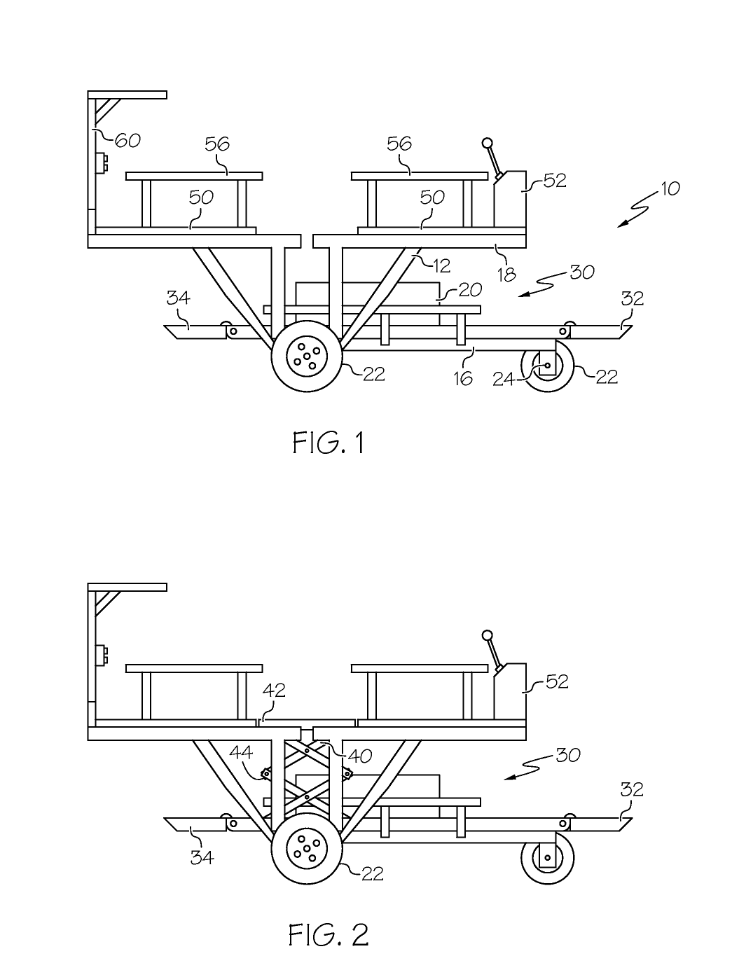

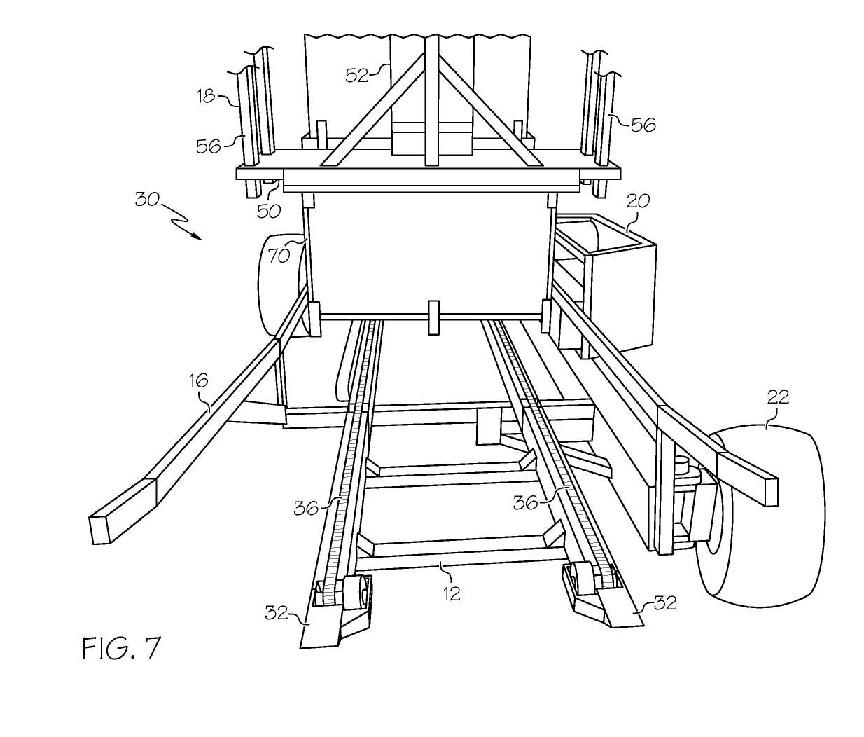

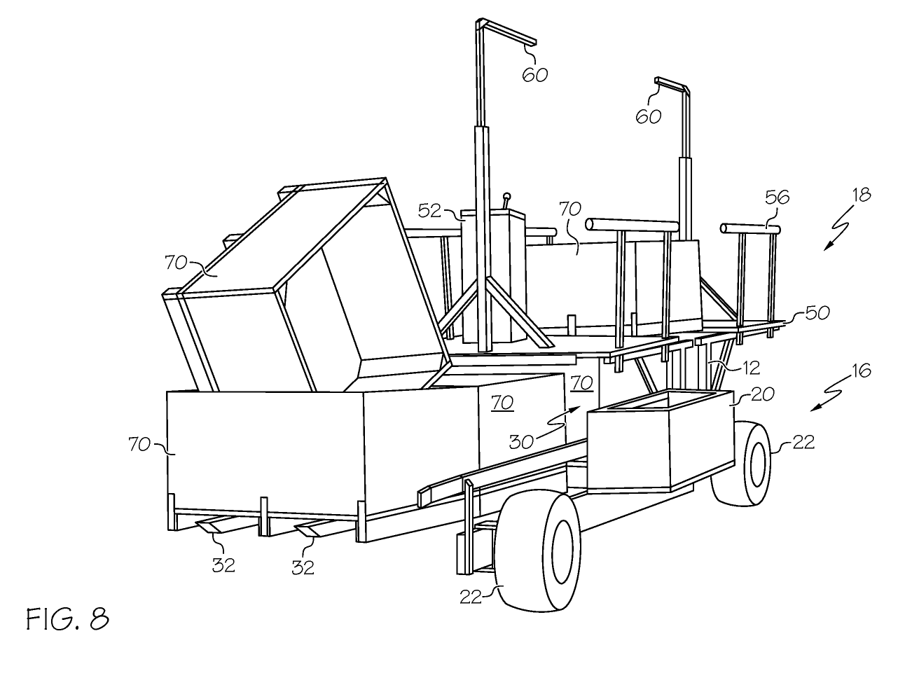

Referring now to FIGS. 1-10, the fruit harvesting machine 10 will now be discussed generally. The fruit harvesting machine 10 may include a frame 12 to support and/or connect additional components of the machine, such as standing platforms 50, drive components 20, hydraulics, bin lift and manipulation systems, and other components. These components may be connected to and/or supported by the frame 12. Additionally, one or more of the components may be interconnected with other components.

The frame 12 will now be discussed in greater detail. The frame 12 may include multiple lengths of strong and rigid material to create a chassis on which the other components may be installed or located. For example, the frame 12 of the fruit harvesting machine 10 may be constructed from one or more folded pieces of steel and/or boxed steel tubes, which run the length of the machine Skilled artisans will appreciate that the frame 12 may be constructed using metals or nonmetallic materials in combination with and/or in substitution of steel, without limitation. The steel or other metallic members of the frame 12 may be welded, bolted, riveted, adhered, or otherwise connected to the other members of the frame 12.

The frame 12 may be configured to include an upper portion 18 and a lower portion 16. The lower portion 16 of the frame 12 may be constructed using a ladder, backbone, perimeter, and/or other frame configuration. Components such as the drive components 20, bin storage compartment 30, bin lift system 40, and hydraulics may be located on or fixed to the lower portion 16 of the frame 12. The upper portion 18 of the frame 12 may be located above the lower portion 16 of the frame 12. Components such as the standing platforms 50, operating console 52, arm 60, and other attachable components may be located on or fixed to the upper portion 18 of the frame 12.

The upper portion 18 may be supported by one or more vertical members of the frame 12 and optionally one or more diagonally positioned braces, which may distribute and support the weight of the upper portion 18 of the frame 12. The upper portion 18 of the frame 12 may be constructed in one or more additional portions. For example, the upper portion 18 of the frame 12 may be one monolithic construction, which may be attached permanently or temporarily to the lower portion 16 of the frame 12. Alternatively, the upper portion 18 of the frame 12 may include two adjacently located portions, which may permanently or temporarily attach to the lower portion 16 of the frame 12 separately. Skilled artisans will appreciate additional embodiments with differing number of portions that collectively create the upper portion 18 of the frame 12. In the interest of clarity, and without limitation, the following disclosure will be discussed concerning an embodiment in which the upper portion 18 of the frame 12 includes two portions, a front upper portion and rear upper portion.

The standing platforms 50 will now be discussed in greater detail. As discussed above, the standing platforms 50 may be located on or fixed to the upper portion 18 of the frame 12. More specifically, a front standing platform may be attached to the front upper portion of the frame 12 and a rear standing platform may be attached to the rear upper portion of the frame 12. The standing platforms 50 may be welded, bolted, or otherwise attached to the upper portions of the frame 12. In an alternative embodiment, the standing platforms 50 may be the same structural member as the respective upper portion 18 of the frame 12. The standing platforms 50 may include a surface on which a user and/or operator may stand.

Railings 56 may be connected to one or more of the standing platforms 50, which may decrease the likelihood of a user falling off the platform. The railings 56 may include vertical and horizontal railing members. The vertical railing members may connect to the platform 50 at its bottom end and extend upward from the platform 50, for example, from an edge of the platform 50. A position along the length of the horizontal railing member may connect to a top end of the vertical railing member. The horizontal member may optionally extend beyond the connecting point with the vertical railing member, as illustrated in FIGS. 1-2. Optionally, the horizontal railing members may be configured approximately parallel to the surface of the standing platform 50. Additionally, the vertical railing members may optionally be configured approximately orthogonal to the platform 50 and the horizontal members. However, skilled artisans will appreciate additional configurations of the horizontal and vertical members to be included without limitation.

The fruit harvesting machine 10 may include an operating console 52, which may be located on the platform 50 of the upper portion 18 of the frame 12. Alternatively, the operating console 52 may be connected directly to the upper portion 18 of the frame 12. The operating console 52 may provide controls for a user to interact with and control operation of the machine. For example, the operating console 52 may include controls for the drive system, steering, hydraulic, bin movement via rollers 36, arms 60, lights, and/or bin lift system 40. The operating console 52 may be operatively connected to the systems controlled by the console. In an example, as illustrated by FIGS. 1-2, the operating console 52 may be located on a standing platform 50 attached to the front of the upper portion 18 of the frame 12.

An arm 60 may be located on or attached to the standing platform 50 and/or the upper portion 18 of the frame 12. An example of an arm 60 attached to the upper frame 12 is provided by FIG. 1. The arm 60 may include tools or accessories to facilitate the operation of the fruit harvesting machine 10. For example, the arm 60 may include a light to illuminate an area of a field or orchard being harvested, advantageously allowing fruits or crops to be harvested at night. In another example, the arm 60 may include a gripper or claw to harvest fruit or crops that would be otherwise out of reach of an individual. Skilled artisans will appreciate additional configurations or accessories that may be provided by or attached to the arm 60 after having the benefit of this disclosure.

The drive components of the fruit harvesting machine 10 will now be discussed in greater detail. The drive components may include one or more axle 24 to which wheels 22 may be attached. For example, as illustrated in FIG. 1-3, the fruit harvesting device may include a rear axle with two attached wheels 22 and a partial front axle with one attached wheel 22. Other embodiments may include two or more axles 24. For example, an embodiment with two axles 24 may include a front axle and a rear axle with two wheels 22 attached to each axle.

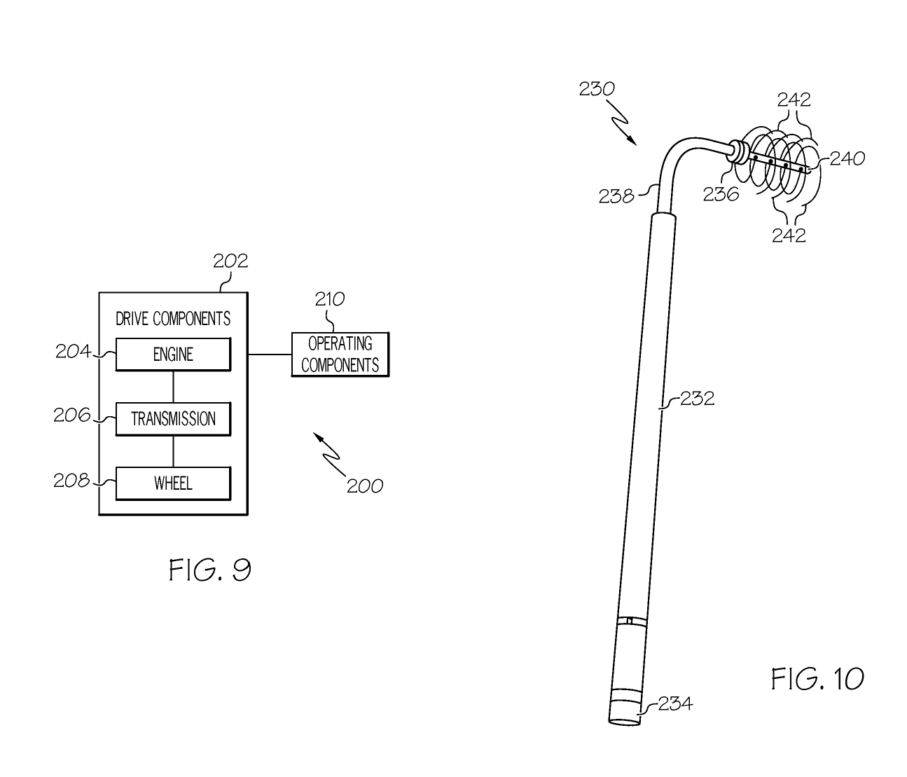

Referring to block diagram 200 of FIG. 9, the drive components will now be discussed. The drive components 202 may include an engine 204, transmission 206, and one or more wheels 208. The transmission 206 may convert rotational motion generated by the engine 204 into an appropriate rotational motion to drive the one or more wheels 208. The drive components 202 may be connected to and controlled by the operating console 210. The wheels 22 may attach to the frame via a suspension.

The engine 204 of the drive components may be a combustion engine, electric motor, or other propulsion mechanism to drive one or more of the axles and/or wheels and move the fruit harvesting device in a forward and/or backward direction. A hydraulic system may also be included to operate one or more of the components of the fruit harvesting machine, such as the bin lift system, rollers, prongs, and/or arm.

In an exemplary embodiment, without limitation, the maximum width of the tractor may be about 68.5 inches, which can be measured as tire-to-tire width, to enable the tractor to navigate between closely spaced rows of plants. In other embodiments, the maximum width of the machine can be about 48, 50, 54, 55, 60, 65, 66, 70, 72, 75, 78, or 84 inches. The maximum width of the machine can be measured using the two most distant parallel lateral parts of the machine such as, for example, an outer edge of two wheels installed on opposite ends of an axle. The frame of the machine can be about 56 inches in width. In other embodiments, the frame of the machine can be about 36, 40, 48, 50, 54, 55, 60, 66, 70, 75, 78, or 84 inches. In an exemplary embodiment, the machine frame's width can be less than the machine's maximum tire-to-tire width, for example, the distance measured from an outside surface of one tire on an axle to an outside surface of another tire on an opposite end of the same axle.

Referring additionally to FIGS. 1-8 and 10, the fruit harvesting machine 10 may optionally include an air bed ride and suspension to stabilize the machine and bins 70 contained therein as the machine moves across rough terrain such as a plowed field. In one embodiment, the fruit harvesting machine 10 can include a hydraulic suspension system to reduce bouncing and movement of produce carried by the machine. In another embodiment, the fruit harvesting machine 10 can include an air cushion system to soften the movement of produce during transportation by reducing the impact caused by bouncing of the produce within the bins 70. In yet another embodiment, the suspension may be constructed using mechanical parts.

The fruit harvesting machine 10 may include components to load, move, lift, and otherwise manipulate bins 70, which will now be discussed in greater detail. The bins 70 may be included by and/or moved about a bin storage compartment 30, which is located adjacent to the bottom portion 16 of the frame 12. The bin storage compartment 30 of the fruit harvesting machine 10 may include rollers 36, for example, chain rollers, to move the bins 70 in an approximately horizontal direction. The rollers 36 may be installed on the floor of the bin storage compartment 30. In one embodiment, the floor of the storage compartment 30 may include a solid horizontally planar surface extending the width and length of the storage compartment. In an exemplary embodiment, the floor of the storage compartment 30 can be two or more support rails disposed longitudinally and collinearly across the length of the storage compartment.

One or more chain rollers may be installed to move the bins 70 about the storage compartment. The rollers 36 may be passive or may be actively controlled substantially mechanically, such as hydraulically or via a motor, without limitation, to move bins 70 to a rearward part of the storage compartment and/or above the bin lift system 40, which will be discussed in greater detail below. In an exemplary embodiment, the rollers 36 maybe mechanical chain rollers and may be reversible in direction so that the fruit harvesting machine 10 can both load and unload bins 70 stored within the storage compartment and/or onto the bin lift system 40.

A front area of the lower portion 16 can include at least two prongs that are vertically adjustable and used to receive bins 70 into the storage compartment. Once received by the prongs, which may feature hydraulic or mechanical lift mechanisms, a bin 70 can be moved into a horizontally rear portion of the storage compartment by the chain rollers. The bins 70 may be moved by the rollers 36 into a position to be received by the bin lift system 40. The chain rollers can be reversed in direction to move a bin 70 from the rear portion to the front portion of the storage compartment where the bin 70 can be unloaded from the fruit harvesting machine 10.

Similarly, the rear area of the lower portion 16 can include at least two prongs that are vertically adjustable and used to guide bins 70 into and from the storage compartment. Similar to operation of the front prongs 32, the rear prongs 34 may guide a bin 70 using hydraulic or mechanical lift mechanisms to allow the bin 70 to be moved horizontally about the storage compartment by the chain rollers. The bin 70 may also be unloaded from the rear portion of the storage compartment of the fruit harvesting machine 10 via passing over the rear prongs 34.

The bin lift system 40 will now be discussed in greater detail. The bin lift system 40 may include a lift surface 42 and a lift mechanism 44. The bin lift system 40 may manipulate the vertical position of a bin 70 placed above the lift mechanism 44, for example, by the rollers 36. The bin lift system 40 may be located on or attached to the frame 12. For example, as illustrated in FIGS. 1-5, the bin lift system 40 may be located above the rear axle of the drive system.

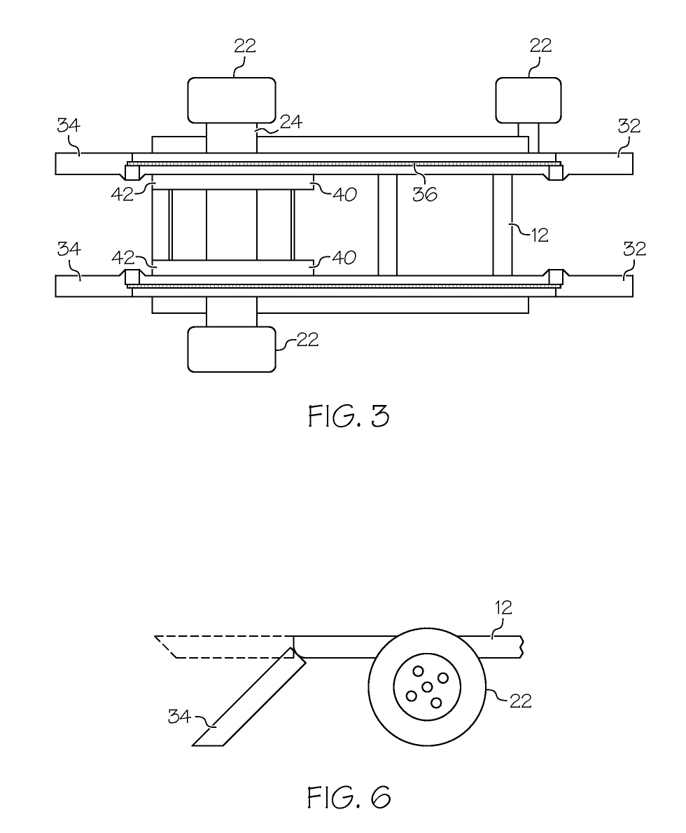

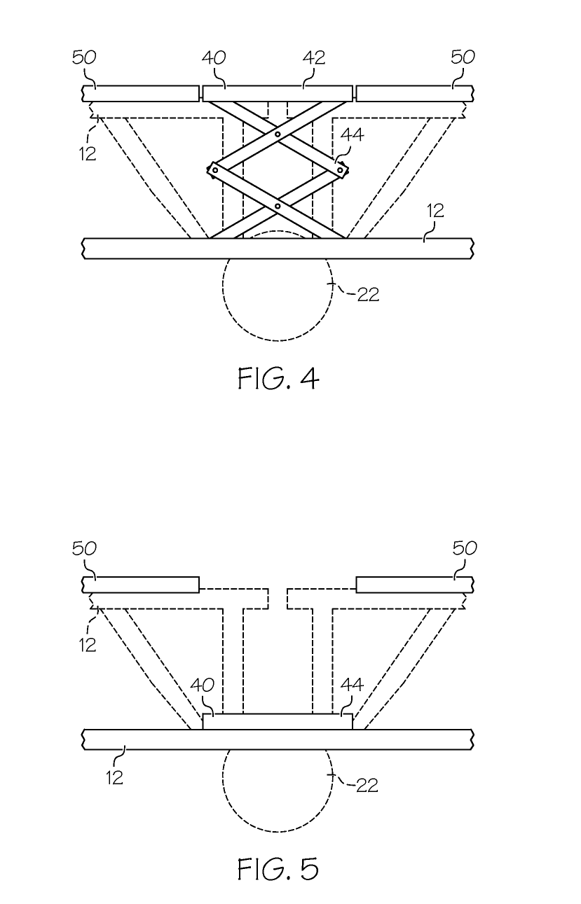

As discussed above, the bin lift system 40 may include a lift surface 42 and a lift mechanism 44. The lift surface 42 may be a planar area, pair of elongated rail surfaces, or other surface that may interact with a bin 70 positioned above the lift surface 42. An example of a lift surface 42 provided by a pair of elongated rail surfaces is illustrated by FIG. 3. A lift mechanism 44 may manipulate the lift surface 42 between a retracted position, extended position, and position variably selected between being fully retracted or extended. An example of the bin lift system 40 being retracted in the lowered position is illustrated by FIGS. 1 and 4. Conversely, an example of the bin lift system 40 being extended in the raised position is illustrated by FIGS. 2 and 5.

As mentioned above, the lift mechanism 44 may vary the vertical position of the lift surface 42. The lift mechanism 44 may be a hydraulic, mechanical, a combination of hydraulic and mechanical, or an otherwise constructed mechanism capable of varying a vertical position. For example, without limitation, the lift mechanism 44 may include mechanical and hydraulic components to create a scissor lift. As illustrated in FIGS. 1-5, a scissor lift includes a plurality of linked, folding supports that cross one another at multiple fulcra. The lift surface 42, which may be connected to the upper end of a lift mechanism 44 configured as a scissor lift, may be elevated as pressure is applied to the outside of the lowest set of supports. As the pressure is applied, the crossing pattern may be contracted horizontally and elongated vertically, extending the lift surface 42 upward. This pressure may be supplied via hydraulic, pneumatic, lead screw, rack and pinion, or other mechanical system. To descend the lift surface 42, pressure may be removed from the lowest set of supports in reverse of the lifting operation described above. Skilled artisans will appreciate additional lift mechanisms contemplated by the present invention after having the benefit of this disclosure.

The bins 70 may be specially designed featuring one or more channels or grooves on a bottom surface of each bin 70 for receiving the prongs 32, 34 of the fruit harvesting machine 10. The operator may maneuver the fruit harvesting machine 10 to align the prongs with the channels of a bin 70. The prongs may slide into the channels and, as the prongs are lifted vertically, the bin 70 can also be lifted and moved about the storage compartment by the chain rollers or other mechanical or manual components.

In an embodiment, the operating console 52 may be elevated above the storage compartment 30 by a plurality of support elements of the upper portion 18 of the frame 12. For example, positioning the user or operator of the fruit harvesting machine 10 at a level respective to the fruit trees may facilitate gathering of fruit or crops from the trees as the fruit harvesting machine 10 moves between rows in an orchard.

The fruit harvesting machine 10 can further include a camera to facilitate the loading and unloading of bins 70 into and out of the storage compartment 30. The camera may be linked to a monitor installed on or near the operating console 52 so that the machine's driver or operator can control the alignment of the machine's storage compartment 30 and rollers 36 with a bin 70 in a field, vineyard, or orchard that is to be loaded.

In one embodiment, the fruit harvesting machine 10 can be manufactured in multiple sizes, shapes, or versions of three pieces (the frame, the body, and the motor) that can be interchanged or recombined depending upon the user's need. The body can include the storage compartment 30 and operating console 52. The frame 12 can be an axle frame. For example, the manufacturer may produce several versions of the body frame that can be connected interchangeably to the chassis.

The plants can be fruit trees, vegetables, fruit bushes, low-growing fruit, or vegetable plants. In an exemplary embodiment, the plants can be a dwarf variety of fruit trees. For example, the fruit trees can be dwarf variety apples. In another embodiment, the fruit harvesting machine 10 may be used to collect and transport grapes from a vineyard.

In operation, the fruit harvesting machine 10 advantageously facilitates harvesting fruits, vegetables, and other crops or items by providing increased accessibility to the crops and bins 70 used to store the harvested crops. Generally, the fruit harvesting machine 10 is used by positioning the machine near the fruit or crops to be harvested, positioning a bin 70 near the user harvesting the fruit, exchanging a filled bin with a new bin, and transporting the bins 70 to another location, such as a processing facility.

More specifically, the fruit harvesting machine 10 may be positioned near the fruit or crops to be harvested by driving the machine using the operating console 52. For example, in an embodiment wherein the machine is driven using a combustion engine, an operator may interact with the operating console 52 to control the throttle of the engine, the direction of the wheels 22 to steer the machine, and any included brakes to slow or stop the machine.

The machine may include an auto-steer mechanism, which may direct the orientation of one or more wheels 22. Through controlling at least one wheel 22, the machine's direction of locomotion may be controlled. The auto-steer mechanism may be programmed with an anticipated path for the machine to follow during its operation. Alternatively, the auto-steer mechanism may adaptively determine a path during locomotion. Those of skill in the art will appreciate additional techniques to automatically steer the machine that are consistent with the scope and spirit of the present invention.

In an additional embodiment, the machine may be towed behind a truck, tractor, or other vehicle for at least part of the distance between an originating location and a harvesting location, such as a field or orchard. Additionally, the machine may be towed behind a truck, tractor, or other vehicle during operation. In exemplary embodiments, the machine can be towed behind half-ton pickup trucks or larger trucks. When towed during operation, the towing vehicle may provide at least part of the locomotion. The machine may be attached to a vehicle for towing via a hitch, ball, chain, line, bar, or other form of coupling. For example, a tow hitch may be fixedly or removably attached to the chassis of the fruit harvesting machine 10, which may be operatively connected to a towing vehicle. Alternatively, the machine may be operatively configured to receive a towing mechanism located on another vehicle, for example, by fitting a coupling of the machine about a tow-ball located on the towing vehicle. Those of skill in the art will appreciate the preceding examples have been provided without limitation. As such, skilled artisans will appreciate additional configurations by which the machine may be connected to and towed by a truck, tractor, or other vehicle.

Once the fruit harvesting machine 10 has been positioned near the fruit or crops to be harvested, the machine may position a bin 70 next to one or more user. The fruit harvesting machine 10 may first receive a bin 70 via the prongs 32, 34, which may be angled downward such that the distal end of the prongs 32, 34 contact or move adjacent to the ground. A bin 70 may then be received by the prongs and positioned onto the rollers 36. Examples of positioning the bins 70 on the rollers may include driving the fruit harvesting machine 10 forward and scooping the bottom end of the bin 70 onto the rollers 36, using a wench, or connecting an attachment or extension of the bin 70 to one or more corresponding portions of the rollers 36.

Once the bin 70 has been received by the rollers 36 and has been included in the bin storage compartment 30, the bin 70 may be moved about the bin storage compartment 30. If the bin 70 was received by the front end of the fruit harvesting machine 10, the bin 70 may be moved rearward and positioned above the bin lift system 40. Once the bin 70 is located above the bin lift system 40, the rollers 36 may be stopped. The operator may then engage the bin lift system 40 to elevate the lift surface 42. As the plane of the lift surface 42 rises above the plane of the rollers 36, the lift surface 42 may engage the bottom surface of the bin 70, lifting the bin 70 upward. The bin lift system 40 may continue to lift the bin 70 upward until it reaches a desired elevation. An example of a desire elevation may be approximately level with the standing platforms 50.

Once the bin 70 has been positioned at a desired level by the bin lift system 40, the harvesting users may harvest the fruit or crops, placing the collected fruit or crops into the bin 70. Eventually, the bin 70 may become filled and require removal or replacement. To replace a bin 70, the user may lower the bin 70 using the bin lift system 40 to be received and supported by the rollers 36 as the lift surface 42 passes below the plane of the rollers 36. The bin 70 may then be moved away from the bin lift system 40 by the rollers 36 and optionally replaced by a new or empty bin. The filled bin may be moved toward the rear of the fruit harvesting machine 10, wherein it may be directed to the ground via the rear prongs 34, which may be configured in a downward orientation. Alternatively, the bin 70 may be directed to the front of the harvesting machine to be stored or deposited to the ground via the front prongs 32.

After the full bin has been removed, or simultaneously as the bin 70 is being removed from above the bin lift system 40, a new bin 70 may be positioned above the bin lift system 40. The bin lift system 40 may then lift the new bin 70 into a convenient position to be filled by the harvesting users. This operation may be continually repeated until the harvesting concludes. At least some of the bins 70 may then be collected by the fruit harvesting machine 10 via the bin storage compartment 30 and transported to a second location, such as, for example, a sorting facility, a washing facility, and/or a packaging facility.

The fruit harvesting machine 10 and method can be used to load and unload about 500-700 bins per day. However, skilled artisans will appreciate this number may be lesser or greater depending upon the number of hours worked, road/terrain conditions, and length of transport from field to loading dock.

In another embodiment, the fruit harvesting machine 10 may be used in pruning operations. During pruning operation, one or more operators may use the hydraulic operated components of the machine, such as a lopper, to access and/or prune trees. Pruning operations that may be performed or facilitated using the machine include dead-wooding, crowning, canopy thinning, crown canopy lifting, directional pruning, formative pruning, vista pruning, pollarding, thinning, topping, raising, reduction, or other pruning operations that would be apparent to one of skill in the art. Optionally, the machine may be operated for pruning without carrying any bins 70. Alternatively, bins 70 may be carried by the machine during pruning operation to collect deadwood, carry tools, or otherwise assist the users of the machine.

In another embodiment, discussed with the illustration of FIG. 10, the fruit harvesting machine 10 may include attachments to extend the functional use of the machine. For example, one or more bloom thinner attachment 230 may be included by and/or attached to the fruit harvesting machine 10. A bloom thinner attachment 230 may be fixedly or removably attached to the machine. Additionally, single or multiple bloom thinners, or other attachments, may be attached to the fruit harvesting machine 10. In embodiments where the attachments are removable, the attachments may include similar fittings to provide interchangeability.

The bloom thinner attachment 230 will now be discussed in more detail. As illustrated in FIG. 10, a bloom thinner attachment 230 may include an elongated rod 232 with a first end 234 having an attachment connection and a second end 236 having a rotating member. The attachment connection at the first end may be hydraulic and driven by a hydraulic system of the fruit harvesting machine 10, such as via an auxiliary valve and/or hose. The bloom thinner attachment 230 may include an approximately cylindrical length of material, such as metal, that extends from its first end 234 toward a second end 236. The attachment connection may be operatively connected to the rotating member, for example, via an axle enclosed within the elongated rod 232. The bloom thinner attachment 230 may include a bend 238 in the rod near the second end 236 to orient the rotating member 240 at an angle skewed from the elongated rod 232.

The rotating member 240 of the bloom thinner attachment 230 may include one or more lengths of material 242 extending outwardly from the rotating member 240. The lengths of material 242 may be metallic, plastic, woven, or otherwise formed. Optionally, the lengths of material 242 may be flexible, allowing the material to fully extend when rotated about the rotating member 240 at a sufficient rotational velocity. By being flexible, each length of material 242 may deform when contacting a rigid object, such as a tree. Alternatively, the lengths of material 242 may be formed via another structure, such as a chain, series of links, connected rods, rigid rods, or other structures that would be apparent after having the benefit of this disclosure.

Connection and use of an embodiment of the bloom thinner 230 attachment will now be discussed. The bloom thinner 230 may be connected to the fruit harvesting machine 10 via a hose or other connective structure. For example, the bloom thinner 230 may be hydraulically attached to the fruit harvesting machine 10 via a hydraulic hose. A user may hold the bloom thinner 230 attachment via the elongated rod 232, substantially reducing the likelihood of the user contacting any moving parts. Fluid may be directed through the hydraulic hose, which may rotate a component of the attachment connection. The rotational motion created at the attachment connection may be operatively transferred to the rotating member 240, which may also rotate the attached lengths of material 242. These lengths of material 242 may then be used to engage an object, such as a bloom of a tree for thinning.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A fruit harvesting machine comprising:
a frame comprising an upper portion and a lower portion;
a platform located at the upper portion;
a bin storage compartment located at the lower portion;
a bin lift system to move a bin between the lower portion and the upper portion;
an operating console accessible from the platform;
drive components attached to the frame to move the machine, the drive components being at least partially controllable via the operating console;
a wheel operatively attached to the frame;
wherein the bin is movable about the bin storage compartment when located in the lower portion;
wherein the bin is storable in the lower portion.

2. The machine of claim 1, wherein the drive components further comprise an engine, and a transmission.

3. The machine of claim 1, further comprising a suspension located between the frame and the wheel.

4. The machine of claim 3, wherein the suspension is an air ride suspension.

5. The machine of claim 1, further comprising rollers located in the lower portion to move the bin.

6. The machine of claim 1, wherein the maximum width of the frame is sufficiently narrow to navigate between closely spaced rows of plants.

7. The machine of claim 1, further comprising prongs located in the lower portion to receive the bin into the bin storage compartment.

8. The machine of claim 7, wherein the prongs additionally guide the bin out of the bin storage compartment.

9. The machine of claim 1, further comprising hydraulics.

10. The machine of claim 9, wherein the bin lift system is manipulated between a lowered position and a raised position via the hydraulics.

11. The machine of claim 1, further comprising an arm, wherein a light is installable on the arm.

12. The machine of claim 1, wherein the bin lift system comprises a scissor lift mechanism.

13. The machine of claim 1, further comprising a camera and a monitor to facilitate loading and unloading of the bin.

14. The machine of claim 1, wherein the drive components comprise an auto-steering mechanism to at least partially manipulate the wheel.

15. The machine of claim 14, wherein the auto-steering mechanism navigates the machine along an anticipated path.

16. The machine of claim 1, further comprising a bloom thinner removably connectable to the machine.

17. The machine of claim 1, wherein attachable components are temporarily connectable to the machine, the attachable components being selected from the list consisting of a lopper, a pruner, and a bloom thinner.

18. A method of operating a harvesting machine, the machine comprising a frame comprising an upper portion and a lower portion, a bin lift system, drive components, and an operating console, the method comprising:
(a) navigating the machine to a location with items to harvest via the drive components;
(b) receiving a bin into a bin storage compartment located in the lower portion;
(c) moving the bin within the bin storage compartment via rollers;
(d) locating the bin approximately above the bin lift system oriented in a lowered position;
(e) operating the bin lift system to transition from the lowered position to a raised position to lift the bin approximately to the upper portion, the bin lift system in the raised position being approximately level with a platform located at the upper portion;
(f) harvesting the items; and
(g) depositing the items that are harvested in the bin;
wherein the drive components are controllable via the operating console.

19. The method of claim 18, further comprising:
(h) exchanging the bin that is substantially full with the bin that is substantially empty;
wherein step (h) is repeatable.

20. The method of claim 19, wherein step (h) further comprises:
(i) operating the bin lift system to transition from the raised position to the lowered position to lower the bin that is substantially full;
(j) locating the bin that is substantially full away from the bin lift system;
(k) locating the bin that is substantially empty above the bin lift system;
(l) operating the bin lift system to transition from the lowered position to the raised position to lift the bin that is substantially empty approximately to the upper portion, the bin lift system in the raised position being approximately level with the platform.
